(19) United States
(12) Patent Application Publication
(10) Pub. No.: US 2026/0151956 A1
(43) Pub. Date: Jun. 4, 2026

(54) Composite material for hose liners

(71) Applicant: Tenowo GmbH, Hof (DE)

(72) Inventors: Mirko Bauer, Chemnitz (DE); Gelena Fischer, Frankenberg/Sa. (DE)

(21) Appl. No.: 19/385,964

(22) Filed: Nov. 11, 2025

(30) Foreign Application Priority Data
Dec. 2, 2024 (DE) 102024135676.6

(51) Int. Cl. B29C 63/34; B32B 17/04; B32B 27/36; F16L 55/165

(52) U.S. Cl. CPC B29C 63/34; B32B 17/04; B32B 27/36; F16L 55/1656; B32B 2262/101; B32B 2307/54; B32B 2367/00; B32B 2597/00

(57) ABSTRACT

The invention relates to a composite material for hose liners for trenchless pipe or sewer renovation, comprising at least one ply of a fibrous web. According to the invention, the at least one ply consists of a longitudinally laid, water-jet-bonded nonwoven fabric made of staple fibres.

The invention relates to a composite material for hose liners for trenchless pipe or sewer renovation, comprising at least one ply of a fibrous web and the use of a longitudinally laid, water-jet-bonded nonwoven fabric made of staple fibres.

DE 3 906 057 A1 already discloses a method for lining a pipe laid in the ground using a lining hose comprising at least one layer of a fibrous web, the fibrous web layer of said lining hose being impregnated with a curable synthetic resin.

The lining hose is inserted into the pipe, pressed against the inner surface of the pipe to be renovated using a pressure medium, and then the synthetic resin is cured.

DE 3 906 057 A1 addresses the problem of developing an improved method for renovating a pipe laid in the ground in such a way that an intensive adhesive bond between the lining hose and the pipe to be renovated can be achieved with a relatively small amount of well-adhering synthetic resin that cures stress-free.

In this regard, the lining hose is to be formed from an outer layer and an inner layer, each consisting of a fibrous web, and a thin, liquid-impermeable barrier layer arranged between the aforementioned layers.

The thickness of the outer layer can be selected to influence the amount of synthetic resin coating that adheres well to the inner surface of the old pipe and cures stress-free.

The inner layer of the lining hose, consisting of fibrous web, can be impregnated with a polyester resin to which a chemical agent is added to reduce shrinkage during curing of the polyester resin.

Specifically, the fibrous web should contain a polyester or glass fibrous web or a combination of polyester fibres or glass fibres, or be designed in such a way.

The use of a composite material for trenchless pipe or sewer renovation, comprising a Kunit or Multiknit nonwoven fabric in combination with a knitted fabric, is also known. However, the structure and uneven surface of the nonwoven fabric, which is difficult to coat, and the lack of dimensional stability of the knitted fabric are problematic here.

A composite of needle-punched nonwoven and knitted fabric with subsequent coating is known, for example, from DE 69115472 T2.

Based on the above, the object of the invention is to provide a further developed composite material for hose liners for trenchless pipe or sewer renovation, which is cost-effective, has excellent elongation behaviour and an optimal surface that is very well suited for subsequent coating steps.

The object of the invention is achieved by a composite material as defined in claim 1 and the use of a longitudinally laid, water-jet-bonded nonwoven fabric made of staple fibres as defined in claim 13, wherein the dependent claims comprise at least expedient embodiments and developments.

It is therefore assumed that a composite material for hose liners or hose inliners for trenchless pipe or sewer renovation is used, comprising at least one ply of a fibrous web.

The at least one ply consists of a longitudinally laid, water-jet-bonded nonwoven fabric made of staple fibres.

The water-jet-bonded nonwoven fabric preferably comprises fibres made of organic polymers, in particular polyester fibres, or contains these fibres.

In a first embodiment, the water-jet-bonded nonwoven fabric contains crimpable fibres formed as two-component fibres, wherein the two components have different heat shrinkage behaviour.

The proportion of crimpable fibres is preferably in the range of ≥50% based on the total fibre mixture.

The fibre fineness of the fibres used is preferably in the range between 1 and 4 dtex.

The composite material may additionally comprise at least one ply of Kunit and/or Multiknit nonwoven fabric and/or at least one ply of glass fibres or a glass fibre mat.

To form the composite, the individual plies or layers are preferably needled.

The ply of longitudinally laid, water-jet-bonded nonwoven fabric may contain a binder for fixing the fibre positions.

The binder may in turn be formed as an aqueous polymer dispersion and/or as a binding fibre component.

By selecting the needle penetration density and depth for the needling, a separation force of the individual plies in the range of greater than 10 N/5 cm is achieved.

When using plies of Kunit nonwoven fabric or Multiknit nonwoven fabric, the water-jet-bonded nonwoven fabric is preferably applied to the mesh side of the Kunit nonwoven fabric or to the first mesh side of the Multiknit nonwoven fabric.

When combined with Kunit/Multiknit, the water-jet-bonded nonwoven fabric of the first embodiment has a basis weight in the range of 30 to 150 g/m² and a longitudinal elongation in the range of 50 to 100% as well as a transverse elongation of at least 100%.

The invention also relates to the use of a longitudinally laid water-jet-bonded nonwoven fabric made of staple fibres as at least one ply of a hose liner or hose inliner for the renovation of pipes or sewers.

The particular advantage of the described longitudinally laid nonwoven fabric lies in its intrinsically high capability for transverse elongation with predeterminable capability for longitudinal elongation and, at the same time, high longitudinal strength.

For example, in combination with a glass fibre mat for large pipe diameters, such a nonwoven fabric according to the invention can be used as an outer ply in the direction of the coating or film of a hose liner. In this application, high strength with low elongation in the range of less than 50% in the longitudinal direction is important. Crimped fibres are not used.

This nonwoven fabric also serves as reinforcement in the longitudinal direction, so that additional reinforcement plies can be reduced or omitted.

For smaller pipe diameters, it is combined with Kunit/Multiknit. Here, an average elongation of greater than 50% in the longitudinal direction and the use of crimped fibres are required.

In principle, there is an advantageous high capability of elongation in the transverse direction and adaptability of the elongation in the longitudinal direction without impairing the capability for elongation in the transverse direction.

As mentioned, the water-jet-bonded nonwoven fabric consists of organic polymers, for example polyester, PP or PA, preferably polyester standard fibres.

The water-jet nonwoven fabric according to the invention can also be used advantageously with smaller pipe diameters, in particular at bends or transitions.

In this regard, the nonwoven fabric or nonwoven fabric mixture contains a proportion of crimpable fibres.

These crimpable fibres are present as bicomponent fibres, in which two materials with different heat shrinkage behaviour are located next to each other in cross-section.

If a nonwoven fabric with such fibres is subjected to heat treatment, the different shrinkage leads to strong crimping of the fibres and to surface shrinkage of the nonwoven fabric.

The crimping thus results in improved capability for elongation in the longitudinal direction without negatively affecting the capability for elongation in the transverse direction.

At the same time, the basis weight of the nonwoven fabric is increased.

The temperature used for this purpose in the crimping step is in the range of ≥180° C.

In order to achieve the desired effect for the use according to the invention, the crimpable fibre content is ≥50% based on the fibre mixture.

With regard to the process for producing an elongatable, elastic nonwoven fabric by crimping, reference is made to the teaching of DE 10 2008 024 945 B1, which is declared to form part of the subject matter of the present application in its entirety.

Optionally, a binder can be added to the water-jet-bonded nonwoven fabric to fix the fibres in their position. The binder can be introduced in the form of an aqueous polymer dispersion or by adding a proportion of binding fibres.

The composite material according to the invention exhibits excellent elongation behaviour. At the same time, the surface of the water-jet-bonded nonwoven fabric is very uniform, resulting in optimal conditions for subsequent coatings.

It is also possible to use a composite of several plies of water-jet-bonded nonwoven or water-jet nonwoven with one or more plies of Kunit or Multiknit nonwoven fabric.

The combination with one or more plies of Kunit nonwoven fabric or Multiknit nonwoven fabric results in excellent properties due to the resulting high thickness, high volume and very good resin absorption capacity for later use as a pipe liner.

Due to the uniform and very smooth surface of the water-jet nonwoven, coating materials penetrate less deeply, which is advantageous for this ply of the composite material.

In a preferred embodiment, the individual composite plies are fixed to each other by needling.

The needle penetration density and depth for the needling are adjusted so that the separation force of the individual layers is ≥10 N/5 cm. This makes the composite very stable for the subsequent undertaking and prevents it from separating.

Alternatively, the individual plies can also be bonded to each other or to themselves.

Depending on the required weight or necessary thickness and with regard to the specific application, several plies of Multiknit or Kunit nonwoven may also be used, wherein the material structure, such as the basis weight, but also the layer thicknesses may be the same or different in each case.

It is particularly preferable to needle the water jet nonwoven onto the mesh side of the Kunit nonwoven or onto the first mesh side of the Multiknit nonwoven.

The invention will be explained below on the basis of an exemplary embodiment and a comparison of the examples according to the invention with a reference composite material based on knitted fabric.

The water jet nonwoven used in the exemplary embodiment has a basis weight in the range of 30 to 150 g/m with a fibre fineness of 1 to 4 dtex.

The elongation in the transverse direction is at least 100%. The elongation in the longitudinal direction is in the range of 50 to 100%. When crimped fibres are used, elongation in the longitudinal direction of up to 100% is achieved, whereas when standard fibres are used, elongation in the longitudinal direction of <50% is achieved. The advantage of the material according to the invention lies in its fundamentally high capability for elongation in the transverse direction and its predeterminable elongation in the longitudinal direction, which can be adapted to the specific application without impairing the desired high capability for elongation in the transverse direction.

The fibres for the nonwoven fabric consist of organic polymer, preferably polyester.

The crimpable fibres are two-component fibres, preferably also made of polyester, wherein two polyester materials with different shrinkage behaviour at elevated temperatures are arranged side by side in the fibre cross-section.

The nonwoven fabric is produced from staple fibres using a carding process in which the fibres are oriented longitudinally in the machine direction. The fibres are bonded using water jets.

The material is shrunk in a stenter frame at a correspondingly high temperature in the range of >180°, so that the fibres shrink and the desired crimp is achieved.

### EXAMPLE 1

A fibre mixture of staple fibres consisting of 60% standard polyester with a fineness of 1.3 dtex and 40% standard polyester with a fineness of 1.7 dtex is available. This mixture is processed into a longitudinally laid fibre pile by means of carding, consolidated by means of water jets and dried. The basis weight is set to 45 g/m². This material then has a very high maximum tensile strength and low maximum tensile elongation in the longitudinal direction and is particularly suitable as a composite ply and longitudinal reinforcement in combination with glass fibre mats.

### EXAMPLE 2

The starting point is a fibre mixture of staple fibres with 80% crimped fibre with a fineness of 2.2 dtex and 20% standard polyester with a fineness of 1.7 dtex. The mixture is processed into a longitudinally laid fibre pile by means of carding, consolidated by means of water jets and dried. This is followed by heat treatment in a stenter frame at 200° C. This results in shrinkage in the longitudinal direction to 60% of the original length and an increase in basis weight from 36 g/m² to 66 g/m².

The maximum tensile elongation in the longitudinal direction increases significantly from 16% to 77%, while in the transverse direction there is a slight reduction from 161% to 141%.

### EXAMPLE 3

The process is carried out in the same way as described in Example 2. After consolidation, an aqueous binder dispersion of polyacrylate copolymers is applied using a squeeze calender and dried at 140° C. This is followed by a temperature treatment as in Example 2, wherein the basis weight increases from 36 g/m² to 59 g/m² and the maximum tensile elongation in the longitudinal direction increases from 16% to 75%. The elongation in the transverse direction remains virtually unchanged.

### EXAMPLE 4

The water-jet-bonded nonwoven fabric according to Example 2 is needled with two plies of Kunit nonwoven fabric. The Kunit used is the product SVKU13 from TENOWO (registered trademark) with a basis weight of 320 g/m², which has already been used successfully in the field of pipe renovation.

In this case, the meshed side of both Kunit plies is on top and the non-meshed side is on the bottom. The water-jet-bonded nonwoven lies on the meshed side of the upper Kunit. With a needle penetration density of 116 E/cm², the composite adhesion is 20.1 N/5 cm (as the lowest value between two plies).

The weight per unit area is determined in accordance with ISO 9073-1, and the thickness is determined in accordance with ISO 9073-2 with a test pressure of 0.5 kPa and a test area of 25 cm². The maximum tensile force and maximum tensile elongation are determined in accordance with ISO 9073-3, Option B, but with a test speed of 200 mm/min and a clamping length of 100 mm.

The bond strength is tested in accordance with DIN 55543-5 with a different sample width of 50 mm.

The table below shows a comparison of Examples 1 to 4 with a reference example (knitted fabric) in accordance with EP 0 875 713 B1 (Example 2 there).

| Parameter | Unit | Example 1 | Example 2 | Example 3 | Example 4 | Reference * |
|---|---|---|---|---|---|---|
| Basis weight | [g/m²] | 46 | 66 | 59 | 712 | 770 |
| Thickness | [mm] | 0.6 | 0.6 | 0.6 | 6.3 | 3.5 |
| Maximum | [N/5 cm] | 171 | 139 | 149 | 790 | 550 |
| tensile force | | | | | | |
| longitudinal | | | | | | |
| Maximum | [N/5 cm] | 24 | 38 | 31 | 396 | 400 |
| tensile force | | | | | | |
| transverse | | | | | | |
| Maximum | [%] | 25 | 77 | 75 | 76 | 25 |
| tensile force | | | | | | |
| elongation | | | | | | |
| longitudinal | | | | | | |
| Maximum | [%] | 172 | 141 | 168 | 231 | 82 |
| tensile force | | | | | | |
| elongation | | | | | | |
| transverse | | | | | | |

It can be seen that Examples 2 to 4 exhibit better capability for elongation in both directions than the knitted fabric reference. This applies in particular to Example 4, which also has a significantly higher thickness for a similar weight.

Thus, the material according to the invention allows for significantly better adaptation to dimensional jumps and curvatures in pipe systems.

1. A composite material for hose liners for trenchless pipe or sewer renovation, comprising at least one ply of a fibrous web,
characterised in that
the at least one ply consists of a longitudinally laid, water-jet-bonded nonwoven fabric made of staple fibres.

2. The composite material according to claim 1,
characterised in that
the water-jet-bonded nonwoven fabric contains fibres made of organic polymers, in particular polyester fibres.

3. The composite material according to claim 1,
characterised in that
the water-jet-bonded nonwoven fabric contains crimpable fibres formed as two-component fibres, the components of which have different heat shrinkage behaviour.

4. The composite material according to claim 3,
characterised in that
the proportion of crimpable fibres is preferably in the range of ≥50% of the total fibre mixture.

5. The composite material according to claim 1,
characterised in that
the fibre fineness is in the range between 1 and 4 dtex.

6. The composite material according to claim 1,
characterised in that
furthermore at least one ply of Kunit and/or Multiknit nonwoven fabric and/or a ply of glass fibres or a glass fibre mat layer is provided.

7. The composite material according to claim 6,
characterised in that
the plies are needled to form a composite.

8. The composite material according to claim 1,
characterised in that
the ply of longitudinally laid, water-jet-bonded nonwoven fabric contains a binder for fixing the fibre positions.

9. The composite material according to claim 8,
characterised in that
the binder is fomed as an aqueous polymer dispersion and/or binding fibres.

10. The composite material according to claim 7,
characterised in that
the separation force of the individual plies is in the range of ≥10 N/5 cm.

11. The composite material according to claim 6,
characterised in that
the water-jet-bonded nonwoven fabric is applied to the mesh side of the Kunit nonwoven fabric or to the first mesh side of the Multiknit nonwoven fabric.

12. The composite material according to claim 1,
characterised in that
the water-jet-bonded nonwoven fabric has a basis weight in the range of 30 to 150 g/m², a maximum tensile force longitudinal elongation in the range of 50 to 100% and a maximum tensile force transverse elongation of at least 100%.

13. Use of a longitudinally laid water-jet-bonded nonwoven fabric made of staple fibres according to claim 1 as at least one ply of a hose liner or hose inliner for the renovation of pipes or sewers.
